(19) United States
(12) Patent Application Publication
(10) Pub. No.: US 2025/0245562 A1
(43) Pub. Date: Jul. 31, 2025

(54) WARM START FOR MULTIPLIER TUNING POSTPROCESSING FOR MACHINE LEARNING BIAS MITIGATION

(71) Applicant: Oracle International Corporation, Redwood Shores, CA (US)

(72) Inventors: Yasha Pushak, Vancouver (CA); Giulia Carocari, Zurich (CH); Hesam Fathi Moghadam, Sunnyvale, CA (US); Rhicheek Patra, Zurich (CH); Hassan Chafi, San Mateo, CA (US)

(21) Appl. No.: 18/666,471

(22) Filed: May 16, 2024

Related U.S. Application Data
(60) Provisional application No. 63/627,380, filed on Jan. 31, 2024.

(51) Int. Cl. G06N 20/00

(52) U.S. Cl. CPC G06N 20/00

(57) ABSTRACT

Here is postprocessing calibration of class probabilities inferred by a machine learning (ML) model, and this calibration is improved by generation of novel initial points that accelerate a genetic algorithm that optimizes fairness and accuracy of the ML model. Tri-objective optimization for multiplier tuning is enhanced by adding a “warm start” mechanism. Innovative designed points are high performance as follows. An identity point has all group multipliers set to 1.0, corresponding to the original model. By definition, this solution will have high accuracy scores and no outcome regression. A parity point has multipliers that have near-perfect disparity and outcome regression. This entails finding multipliers that provide every subgroup approximately the outcome rate of the subgroup with the highest outcome rate. An opportunity point has multipliers that give an approximation of the outcome rate given by an Equality of Opportunity algorithm. This solution provides near-optimal values for accuracy and disparity.

### BENEFIT CLAIM

This application claims the benefit under 35 U.S.C. § 119(e) of provisional application 63/627,380, filed Jan. 31, 2024, by Yasha Pushak et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### FIELD OF THE INVENTION

The present invention relates to postprocessing calibration of class probabilities inferred by a machine learning (ML) model. Herein is novel generation of initial points that accelerate a genetic algorithm that optimizes fairness and accuracy of the ML model.

### BACKGROUND

Machine learning (ML) models can often be used in applications where their decisions will directly impact people. In these sensitive applications, one must be careful so that the ML models' automated decisions do not disproportionately affect different subgroups of a population. For example, a selection tool should not systematically favor one kind of candidates. While methods have been proposed to mitigate unintended bias present in machine learning models, it remains challenging to train an ML model that satisfies high levels of fairness and accuracy at the same time.

Shortcomings in the state of the art include at least the following.
Use of random selection or random generation to generate or adjust an inference is nondeterministic, which means that an inference might not be repeatable, which may complicate an attempt to explain an inference.
Preprocessing of a training corpus or adjustment inside an ML model may require retraining the ML model, which is slow and may discourage exploration and comparison of solution variations.
Only binary classification between two classes may be supported.
An inferred probability or an inferred score may, by adjustment, become outside a supported range, which alters a classification boundary and will break any predefined threshold such as an anomaly detection threshold.
Lack of configurability may cause acceptance of a suboptimal generated solution, and a generated solution is fragile and may break if requirements or data evolve.

In the state of the art, fairness maximization may be oversimplified as a single objective. As discussed later herein, a single overall fairness metric may, for example, be based on all subgroups, including subgroups whose disproportionate effects offset (i.e. cancel out) each other, which may hide unfairness from, for example, an optimizer.

Various optimization algorithms utilize randomness in a search process, such as genetic algorithms, stochastic gradient descent (SGD), simulated annealing, and particle swarm optimization (PSO). Randomness enables an exploration of a search space to escape from a local minimum that is a suboptimal solution. Some stochastic optimization algorithms use randomness to select starting location(s) in the search space from which to being the exploration. A technical problem with a random starting location is that it is statistically likely to be a low-quality initial solution, and the optimization may need much time (i.e. latency) to explore sufficiently far from the starting location to discover a new location that is better than average. That latency, referred to herein as warm up, is spent identifying and evaluating many solutions, all of which are discarded as undesirable. In other words, warm up effectively is a waste of processing time that is a precious computer resource.

### BRIEF DESCRIPTION OF THE DRAWINGS

In the drawings:

FIG. 1 is a block diagram that depicts an example computer that generates novel initial points that accelerate a genetic algorithm that optimizes fairness and accuracy of a trained classifier;

FIG. 2 is a flow diagram that depicts an example computer process that calibrates classification using a best point whose generation by a tri-objective genetic algorithm is accelerated with designed points;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is postprocessing calibration of class probabilities inferred by a machine learning (ML) model, and this calibration is improved by generation of novel initial points that accelerate a genetic algorithm that optimizes fairness and accuracy of the ML model. Tri-objective optimization for multiplier tuning is enhanced by adding a “warm start” mechanism. As follows, a warm start is the process of finding a set of solutions, each of which is a set of multipliers and their corresponding fairness, accuracy, and outcome regression scores, to bootstrap a genetic algorithm that is evolutionary (i.e. stateful), which means that the genetic algorithm's initial state may affect the outcome. As discussed later herein, outcome regression is an increase in some negative outcomes as an unintended effect of adjusting a model's decision boundary to generally increase fairness.

Herein, warm start means a preoptimized initial state of a genetic algorithm that is better than a random initial state (i.e. randomly generated multiplier values). The genetic algorithm starts with an initial value for each multiplier and, herein, each multiplier has an initial value that is better than a random value. If the genetic algorithm were to naively start with random values per the state of the art, the genetic algorithm would need to initially iterate a several genetic generations before achieving multiplier values as good as the initial values herein. Those initial iterations of a state of the art genetic algorithm are referred to herein as warming up from a cold (i.e. random) start. By optimal initial multiplier values herein, warm up is avoided, which is an acceleration of the genetic algorithm and an acceleration of the computer that operates the genetic algorithm. That is, the state of the art has a cold start that needs extra time to warm up, and herein is a warm start that does not waste time warming up, which is novel. The approach herein is faster than the state of the art and generates a quantitatively (i.e. empirically) better Pareto frontier than the state of the art according to frontier quality metrics discussed below.

Various embodiments may implement any of the following innovative initial solutions. Herein, each generated solution is referred to as a point. Unlike randomly generated solutions, herein are designed points that are innovative and high performance as follows. An identity point has all group multipliers set to 1.0 (i.e. multiplicative identity, i.e. neutral, unweighted), corresponding to the original model. By definition, this solution will have high accuracy scores and no outcome regression. A parity point has multipliers that have near-perfect disparity and outcome regression. This is obtained by finding the multipliers that provide every subgroup approximately the outcome rate of the subgroup with the highest outcome rate. Outcome rates, disparity, protected groups, and sensitive features are discussed later herein. An opportunity point has multipliers that give an approximation of the outcome rate given by an Equality of Opportunity (EO) algorithm as discussed later herein. This solution provides near-optimal values for accuracy and disparity.

Here is postprocessing calibration of class probabilities inferred by a machine learning (ML) model. A tri-objective optimizer tunes a novel combination of three distinct validation metrics, including two distinct fairness metrics, including one that minimizes harm. Postprocessing scales respective probabilities of multiple classes based on an input value of a sensitive feature. Scaling uses a multiplier that is multi-objectively optimized to be an excellent three-way tradeoff between fairness and accuracy. This optimization fulfills the following three concerns for producing ML models that are fairer in industrial application settings.

One concern is enforcement of application-specific fairness. While methods have been proposed to mitigate unintended bias present in ML models, it remains challenging to train a ML model that satisfies high levels of fairness and accuracy at the same time. Herein is a more practical approach to producing models having better fairness scores by discovering a set of models with different fairness-accuracy tradeoffs. This allows an end user to select the model that best matches their specific application's need for fairness and accuracy altogether.

Another concern is being fair and accurate for any metric. There are different ways to measure fairness and accuracy of a given model. Every application has different needs and therefore different relevant metrics to optimize for. The approach herein for increasing a model's fairness is flexible enough to allow any metric to be optimized for. It is possible to optimize any combination of fairness and accuracy metrics.

Another concern is increasing a fairness score without random assignment. The state of the art may increase a model's fairness by randomly flipping (e.g. reclassifying) some predictions in order to artificially increase or decrease an outcome rate for a protected group. This may be convenient because it simplifies the task of increasing a group's selection rate to picking the percentage of the group's individuals for which predictions should be reclassified to a different label. However, unpredictability of randomness is undesirable behavior in enterprise applications. The approach herein increases a group's selection rate by picking among its individuals that are most likely to have the desired label. For example, to increase the number of some kind of candidates selected in screening decisions, this approach selects the candidates that the ML model already identified as nearest to being selected, instead of randomly sampling from rejected candidates of that kind.

This approach entails multiplier tuning for postprocessing that is straightforward to implement. This approach increases or decreases the majority class's predicted probability by multiplying by different magnitudes for every protected group. The intuition behind this effectively entails using a model's output confidence as a ranking of which individuals should be more likely to have their predicted label corrected. Increasing a protected group's selection rate with respect to a label may entail increasing all of the group's predicted probabilities, which increases the amount in the group that attain that label.

Rather than going through the difficult task of learning different multipliers for every label for each class, multiplier optimization may be accelerated by only requiring a multiplier for manipulating the predictions of the majority class, which is the label with the largest number of samples inside the dataset. This design decision of applying a multiplier to the majority class readily extends to multiclass classification, even though existing methods are limited to binary classification (i.e. not multiclass).

Multiplier tuning herein is a multi-objective optimization task that finds postprocessed variations of a model that maximize fairness while minimizing accuracy loss. To this end, there might be no single optimal solution, because some applications may require a perfect fairness criterion while others may find accompanying accuracy loss too prohibitive to reach perfect fairness. Herein, the solution concept for this multi-objective optimization problem is a Pareto frontier that consists of the best found three-way tradeoffs of objectives such as fairness and accuracy. Here, the best tradeoffs represent models that are not outperformed on both metrics by another model variation found. Intuitively, if model variation A was outperformed on both metrics by a model variation B, there is no reason whatsoever to prefer model A over model B. Therefore, model B may be a Pareto optimal model, but model A would not be. Multi-objective optimization is an inherently challenging endeavor.

A tri-objective optimizer produces a better three-way Pareto frontier than a two-way Pareto frontier produced by a bi-objective optimizer. Diversity measures how many points are in a Pareto frontier and/or how much separation (i.e. spacing) is between those points. More diversity is quantitatively better, and the three-way Pareto frontier herein has increased diversity of points. Convergence measures the distance between the generated Pareto frontier and the known correct Pareto frontier. Less distance (i.e. more convergence) is quantitatively better, and the three-way Pareto frontier herein has increased convergence. Thus, convergence measures accuracy of the optimization itself. For convergence and diversity, the three-way Pareto frontier herein is a general improvement over a two-way Pareto frontier, and this improvement is quantitative and technologic.

However, the three-way Pareto frontier herein also is a special improvement for fairness. A two-way Pareto frontier effectively protects fewer protected groups (e.g. ethnicities) than does the three-way Pareto frontier. This novel three-way Pareto frontier is generated inside a computer and by, for example, increasing a count of effectively protected groups, the internal performance of the computer itself is quantitatively improved. The tri-objective optimizer may generate a sequence of validation points, and each point is a distinct maximization of both of ML model accuracy and ML model fairness. An optimization computer that uses this novel combination of three distinct quantitative objectives will generate a Pareto frontier from which a best postprocessing configuration may be selected to increase the fairness scores of machine learning inferences. Increased diversity, increased convergence, and effective protection of more protected groups are three quantitative technologic improvements of the optimization by the computer. Thus, the performance of the optimization computer itself is quantitatively improved.

This approach has at least the following general advantages. It is straightforward to implement. It returns a collection of models for a user to pick from. This allows the user to have the final say in what is the fairness-accuracy tradeoff they prefer for their application. This approach is versatile and can be applied to any machine learning model for binary or multiclass classification to improve any given fairness and accuracy metrics combination. This approach is scalable and only requires a number of operations that is linear with respect to the number of protected groups present in the data. Furthermore, if a validation dataset is available, it does not require training any additional machine learning models because training and retraining is not part of this method.

This approach is deterministic at inference time. Unlike existing bias mitigation postprocessing procedures, this method will always return exactly the same prediction for a given test example, because it does not rely upon random sampling to alter the predictions. This approach returns interpretable probabilities. Other bias mitigation methods directly modify predictions without adjusting the prediction probabilities. This means that the original model prediction probabilities can no longer be interpreted normally. For example, a label that has a prediction probability of 0.99 may in fact not end up being the predicted label with other methods. This also means that any method of scoring the accuracy of a model that relies on prediction probabilities (e.g., log loss, AUC ROC) cannot be used with those methods but can be used herein.

This approach makes business-aligned decisions. That is, the predictions that are changed are those that were closest to having been different in the first place. In a hiring example application, this means that an unqualified candidate will not be selected for hiring if there exists a more qualified candidate in the same protected group. This is not true for existing bias mitigation postprocessing strategies. Postprocessing herein does not entail a threshold. Adjustment caused by applying one multiplier occurs for all of multiple classes.

In addition to all of the above general advantages, this approach has at least the following special innovations. This is the first warm start mechanism for bias mitigation algorithms that considers initial solutions along the accuracy, disparity, and outcome regression axes of the optimization space. This approach is the fastest way to find high-quality multi-objective solutions that are fair by design. Given a fixed set of constraints on each metric, the running time required to find a satisfactory solution using warm starting is less than when compared to running multiplier tuning without warm starting. Thus, for optimization with a fixed time budget, this approach achieves solutions that have unprecedented combined fairness and accuracy.

### 1.0 Example Computer

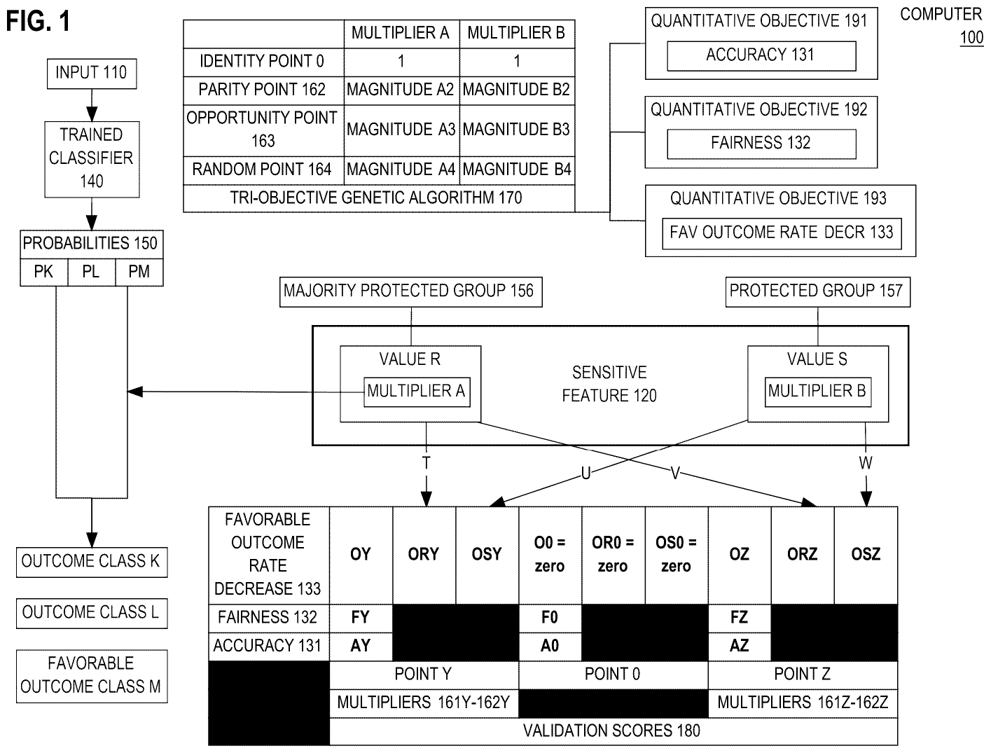

FIG. 1 is a block diagram that depicts an example computer 100, in an embodiment. Computer 100 performs novel generation of initial points 0 and 162-163 that accelerates genetic algorithm 170 that optimizes fairness and accuracy of trained classifier 140. Computer 100 may be one or more of a rack server such as a blade, a mainframe, a personal computer, or a virtual machine.

Computer 100 calibrates probabilities PK-PM inferred by trained classifier 140 that is a machine learning (ML) model. This calibration is postprocessing for scaling of respective probabilities of mutually exclusive outcome classes K-M based on one of multiple values R-S of sensitive feature 120. Sensitive feature 120 deserves special consideration because it is positively or negatively correlated with at least one of protected groups 156-157. Any input herein, such as input 110, is a member of one of protected groups 156-157. In an embodiment, input 110 is a feature vector, such as a one-dimensional array of numbers, that represents a record of a subject such as a person.

Input 110 has a respective value of each of multiple features, including sensitive feature 120. Each feature has a respective datatype such as a number, a string, or a data structure, and all of those datatypes can be numerically encoded in a feature vector such as by one-hot encoding or hash encoding. For example, input 110 has value R of sensitive feature 120, and other inputs (not shown) may have either of values R-S.

### 1.1 Machine Learning Classifier

In one example, trained classifier 140 is an opaque (i.e. black box) ML model that cannot be retrained by computer 100. For example, the user of computer 100 might not know how trained classifier 140 was trained. The user might not know if trained classifier 140's training was supervised or unsupervised.

However, computer 100 is configured to validate trained classifier 140 using a validation corpus that contains input 110 and multiple other inputs. In an embodiment: validation is supervised; the validation corpus is labeled; and each input has a respective label (not shown), which is a known correct classification (i.e. identification of one of outcome classes K-M).

Trained classifier 140 accepts an input, which causes trained classifier 140 to infer (i.e. generate) a learned inference that contains a respective probability for each of outcome classes K-M. For example, trained classifier 140 infers probabilities 150 from input 110. Probabilities 150 contains probabilities PK, PL, and PM respectively for outcome classes K-M.

For example for input 110, probability PM is inferred for favorable outcome class M. The state of the art may maximize accuracy by classifying input 110 as favorable outcome class M if probability PM is the highest in probabilities 150. Herein if probability PM is the highest in probabilities 150, multiplier A may cause input 110 to instead be classified as any of outcome classes K-M as discussed below. Thus, computer 100 classifies input 110 not to strictly maximize accuracy, but instead to minimize a decrease of a favorable outcome rate and maximize fairness and accuracy.

### 1.2 Probability Multipliers

As discussed later herein, computer 100 automatically discovers multiple optima that are respective different three-way tradeoffs between: 1) fairness, 2) accuracy, and 3) a decrease of a favorable outcome rate. Computer 100 can retroactively switch between different tradeoffs without retraining, revalidating, nor otherwise using trained classifier 140. For example, once validation scores 180 are generated as discussed later herein, any of many versions of multipliers A-B of sensitive feature 120 may be retroactively applied to recalibrate any inferred probabilities (e.g. 150) without using trained classifier 140.

Thus architecturally, recalibration by applying multipliers A-B is postprocessing, which is downstream of trained classifier 140. It does not matter if postprocessing occurs immediately after inferring probabilities 150 or deferred until input 110 might need reclassification without using trained classifier 140. In other words, probabilities 150 may be live or archival. For example, retroactive postprocessing of probabilities 150 may occur even if trained classifier 140 was discarded.

Multiplier A, for example, achieves recalibration of probabilities 150 as follows. Herein it does not matter if: a) favorable outcome class M is or is not the most frequent outcome class in the labeled validation corpus, nor b) favorable outcome class M is or is not the class that most frequently has the highest probability in inferences by trained classifier 140.

In one example, probability PM may be the highest in probabilities 150 until probability PM is multiplied by multiplier A to generate a multiplicative product (not shown). Multiplier A is a positive real number that, if less than one, generates a multiplicative product that is less than probability PM. Likewise, multiplier B may or may not be greater than one, which generates a multiplicative product that is greater than probability PM. Because the multiplicative product is used during postprocessing herein as a replacement of the originally inferred probability (e.g. PM) of favorable outcome class M, the probability of favorable outcome class M relative to other outcome classes K-L may be decreased or increased based on which one of multipliers A-B is used, which is dynamically selected as follows.

Herein, each of distinct values R-S of sensitive feature 120 or, in an embodiment not shown, each distinct disjoint (i.e. nonoverlapping) subset of values of sensitive feature 120, has a respective distinct multiplier. Herein, each distinct value or each distinct subset of values of sensitive feature 120 identifies or is associated with one of multiple protected groups 156-157 that are respectively associated with values R-S as shown. For example, value R may be associated with majority protected group 156 by statistical correlation. In an embodiment not shown, there are more than five protected groups, each of which is associated with a distinct respective one of more than five values or value subsets of sensitive feature 120.

In shown example, value R may be: a) the identifier of majority protected group 156 or b) positively correlated with majority protected group 156. As a demonstrative example for (b): i) majority protected group 156 may be teachers, ii) protected group 157 may be students, and iii) value R may be car ownership that is positively correlated with both of majority protected group 156 and mortgage approval that is favorable outcome class M, even though iv) car ownership is not causal (i.e. does not cause mortgage approval). In the case of (b), a few students might own a car, and a few teachers might not. The techniques herein work even if, for example, some members of protected group 157 have value R for sensitive feature 120. For example, input 110 may be a member of majority protected group 156 and not have value R for sensitive feature 120. For example, multiplier A may be selected for input 110 even if input 110 is a member of protected group 157 so long as input 110 has value R. Likewise sometimes multiplier B may be selected even when input 110 is a member of majority protected group 156. In other words, sensitive feature 120, not protected groups 156-157, determines which one of multipliers A-B is selected for input 110.

Herein, protected groups 156-157 may be collectively referred to as a protected attribute. Herein, sensitive feature 120 is also referred to as a predictor variable. Depending on the embodiment, the predictor variable may or may not be the protected attribute and, if not, the protected attribute may or may not be a feature in input 110. In any case, the predictor variable is a feature in input 110. Herein, outcome class K-M may be collectively referred to as a target variable.

Herein, there always are multiple protected groups associated with sensitive feature 120 and thus multiple multipliers as discussed below. The value of sensitive feature 120 in an input determines which of multipliers A-B is selected for that input. For example, multiplier A is selected for input 110 that has value R for sensitive feature 120. Likewise, multiplier B is selected for other input(s) that instead have value S for sensitive feature 120.

For example, probability PM may be the highest in probabilities 150, and multiplier A may cause probability PM to become relatively lower than zero or more of other probabilities PK-PL. For example after applying multiplier A to probability PM, probability PK may become the highest. In that case, input 110 would be classified as outcome class K even though probability PM was originally higher than probability PK.

In another example, trained classifier 140 infers probabilities from another input (not shown). That input has value S for sensitive feature 120, which means that multiplier B is selected for that input. The probability of outcome class L may be the highest in the probabilities inferred from that input, and multiplier B may cause the probability of outcome class M to become relatively higher than zero or more of probabilities of other outcome classes K-L. For example after applying multiplier B to the probability of outcome class M, that probability may become the highest. In that case, that input would be classified as outcome class M even though the probability of outcome class M was originally lower than the probability of outcome class L.

In those ways, a multiplier may more or less immediately cause a live classification to a class of a lower probability. Likewise in those ways after a previous classification of an input, a retroactively applied multiplier may subsequently cause a reclassification of the input to a class of a lower probability.

### 1.3 Multiplier Optimization

The lifecycle of multipliers A-B has an optimization phase followed by an application phase. As follows, optimized generation of multipliers A-B during the optimization phase may be based on optimization components 170 and 180 whose sole purpose is to optimize multipliers A-B, after which those optimization components may be discarded along with the validation corpus, including input 110 and its inferred probabilities 150. In other words, deployment for the application phase might entail only production components 120, 140, A-B, K-M, and R-S.

In production, new inputs may occur that were not in the validation corpus and, for example, did not exist during the optimization phase, and trained classifier 140 may infer new probabilities for those new inputs as discussed later herein. During the optimization phase, all of the components shown in FIG. 1 are stored or generated in random access memory (RAM) in computer 100. The application phase may occur on a same or different computer in a same or different environment as the optimization phase.

The optimization phase has a sequence of many validation points including points 0 and Y-Z. The dark rectangle shown beneath baseline point 0 indicates that point 0 does not use multipliers A-B. For each of points Y-Z, tri-objective genetic algorithm 170 generates a respective distinct pair of magnitudes for multipliers A-B. For example, point Y has multiplier magnitudes 161Y-162Y for respective multipliers A-B.

Herein, a point is defined by its distinct pair of magnitudes for multipliers A-B, and validation scores 180 depend on these multipliers. Herein, a point may also be referred to as a validation or a validation point. That is, multipliers 161Y-162Y and 161Z-162Z are independent variables, and validation scores A0 and AY-AZ, F0 and FY-FZ, O0 and OY-OZ, OR0 and ORY-ORZ, and OS0 and OSY-OSZ are shown bold to indicate that they are dependent variables.

Each point (i.e. its distinct plurality of multipliers as discussed above and later herein) is generated by computer 100 or by tri-objective genetic algorithm 170. In an embodiment, tri-objective genetic algorithm 170 generates every point except initial points 0 and 162-163, including point 0 that lacks multipliers, which computer 100 generates with value one for all multipliers A-B, which is logically the same as no multipliers. Each generated point is evaluated by computer 100 to generate respective (e.g. three) validation scores. Herein, a plurality of multipliers of sensitive feature 120 may be referred to as a point. For example, the pair of multipliers 161Y-162Y is point Y.

In an embodiment, tri-objective genetic algorithm 170 is a multi-objective optimizer into which any amount (e.g. three) of custom objectives may be loaded. In the shown embodiment, tri-objective genetic algorithm 170 has: a) quantitative objectives 191-192 that maximize respective validation metrics 131-132 and b) quantitative objective 193 that minimizes validation metric 133. In other words, for three distinct quantitative objectives 191-193, there are three respective distinct validation metrics 131-133.

### 1.4 Validation Measurements

Validation metrics are distinct and independent of each other. As discussed later herein, some distinct validation metrics may be somewhat conceptually overlapping because they measure fairness in different ways and, in some embodiments, some validation metrics may have partially overlapping implementations.

Supervised validation is based on the labels in the validation corpus as discussed earlier herein. Accuracy 131 is supervised. None, one, or both of fairness metrics 132-133 are supervised or self-supervised.

Validation scores 180 contains individual validation scores A0 and AY-AZ, F0 and FY-FZ, O0 and OY-OZ, OR0 and ORY-ORZ, and OS0 and OSY-OSZ that are shown bold and measured as follows. Herein, a point has a separate validation score for each of validation metrics 131-133. For example, point Y has validation scores AY, FY, and OY respectively for validation metrics 131-133.

Each of accuracy scores A0 and AY-AZ is measured during a respective one of points 0 and Y-Z. Accuracy metric 131 may generally be any model fitness metric, which measures accuracy scores A0 and AY-AZ. For example, many distinct fitness metrics are based solely on a confusion matrix or not based on a confusion matrix.

For each of points 0 and Y-Z, a respective one of fairness scores F0 and FY-FZ is measured. An embodiment may use any of the following classification fairness metrics as an underlying fairness metric to implement fairness 132: Statistical Parity Difference (SPD), Disparate Impact (DI), Equal Opportunity Difference (EOD), Equalized Odds Difference (EOD), Demographic Parity (DP), Conditional Demographic Disparity (CDD), Theil's Information Inequality, Confusion Matrix Disparity (CMD), Consistency Score, and Treatment Equality (TE).

In a preferred embodiment, fairness 132 is one of: true positive rate disparity, false positive rate disparity, and statistical parity. Here, positive means favorable as discussed later herein. For example, favorable outcome class M is favorable. In that case, positive means favorable outcome class M is inferred, and negative means one of other outcome classes K-L is inferred. Here, true means that a same one of probabilities PK-PM is highest both before and after applying multipliers A-B. Here, false means that which one of probabilities PK-PM is highest differs between before and after applying multipliers A-B. In other words and as discussed earlier herein, true is when multipliers A-B do not cause the inference to flip (i.e. change) from one class to a different class.

Fairness metrics 132-133 operate differently as follows. Fairness measurements F0 and FY-FZ may be for a particular protected group (e.g. protected group 157 by itself or relative to majority protected group 156) or may be for all protected groups overall and, in either case, the measurement directly applies a fairness metric to a single set of inferences that are generated during a single validation. All validations may share a same validation corpus (not shown) that contains many inputs, including input 110, and share trained classifier 140 without retraining.

The shown dark rectangle to the right of validation scores AZ and FZ demonstrates that, for point Z, fairness 132 measures only one fairness score FZ, and accuracy 131 measures only one accuracy score AZ. Both of validation scores AZ and FZ are based on only one point Z.

### 1.5 Favorable Outcome Rate

However for point Z, favorable outcome rate decrease 133 measures three favorable outcome rate decreases OZ and ORZ-OSZ that are based on exactly two points 0 and Z. In other words, favorable outcome rate decrease 133 compares one of points Y-Z to point 0.

One of outcome classes K-M is a favorable outcome, which may be inferred for both of protected groups 156-157, but at different rates (i.e. frequencies). For example, if favorable outcome class M is favorable and protected group 157 is, for example, historically disadvantaged, then favorable outcome class M may be more often inferred for value R than for value S, which may be more or less unfair.

Herein, baseline point 0 does not use multipliers A-B and always is validation scored before points Y-Z that use multipliers A-B. As discussed earlier herein, multipliers A-B may flip some class inferences, which means that multipliers A-B may increase or decrease a favorable outcome rate for one, some, or all of protected groups 156-157. A favorable outcome rate for a validation may be a percentage of inferences with favorable outcome class M, for one protected group or for all protected groups.

Favorable outcome rate decrease 133 compares point 0 to, for example, point Y as follows. Favorable outcome rate decrease 133 is biphasic, which means that favorable outcome rate decreases ORY-OSY are measured before measuring overall favorable outcome rate decrease OY that may, for example, be an average of favorable outcome rate decreases ORY-OSY.

Dataflows T-U of point Y occur during the first phase of favorable outcome rate decrease 133. The validation corpus contains many inputs, including 110. Only inferences from inputs in majority protected group 156 are used to measure a favorable outcome rate (not shown) for majority protected group 156.

In one example as discussed earlier herein, a distinct value or subrange of distinct values of sensitive feature 120 identifies a distinct protected group. In other examples, sensitive feature 120 does not identify protected groups but, instead, sensitive feature 120 is correlated: a) to another sensitive feature that does identify protected groups and/or b) directly to the protected groups, which are not based on sensitive feature 120.

Dataflow T is biphasic, which means that a favorable outcome rate (not shown) for majority protected group 156 is measured before measuring favorable outcome rate decrease ORY by subtracting point Y's favorable outcome rate for majority protected group 156 from point 0's favorable outcome rate (not shown) for majority protected group 156. Dataflow U demonstrates that favorable outcome rate decrease OSY is measured in a same way, except that the protected group is 157 instead of 156.

If favorable outcome rate decrease ORY is non-negative (i.e. not less than zero), then majority protected group 156 is not harmed by multipliers A-B. If favorable outcome rate decrease ORY is negative, then favorable outcome rate decrease ORY is treated as if it were rounded up to zero when using favorable outcome rate decrease ORY to measure overall favorable outcome rate decrease OY. In this example, a lower favorable outcome rate decrease 133 is better, and zero is best. For example if overall favorable outcome rate decrease OY is zero, none of protected groups R-S are harmed by multipliers 161Y-162Y.

Fairness metrics 132-133 are different, and different tradeoffs between them and between accuracy 131 may be generated by tri-objective genetic algorithm 170. Each of points Y-Z has a distinct tradeoff between metrics 131-133, and there may be many points. As discussed below, a Pareto frontier identifies a best subset of points, and (e.g. interactive) selection of a single best point may or may not be subjective.

Favorable outcome rate decrease 133 may compare baseline point 0 to either of points Y-Z. However, comparing point 0 to itself is unnecessary because all of favorable outcome rate decreases O0 and OR0-OS0 are always zero as shown. In other words, favorable outcome rate decrease 133 is a validation metric that is not applied to point 0.

### 1.6 Multi-Objective Optimizer

Tri-objective genetic algorithm 170 is exploratory in an evolutionary (i.e. generational) way. For example, tri-objective genetic algorithm 170 may receive initial validation scores F0 and A0 that respectively are a fairness score and an accuracy score as shown in validation scores 180. In an embodiment, tri-objective genetic algorithm 170 is a multi-objective evolutionary algorithm (MOEA) such as a fast and elitist multi-objective genetic algorithm such as non-dominated sorting genetic algorithm II (NSGA-II) that has a python implementation that is open source.

Initial validation scores F0 and A0 are based directly on original probabilities as inferred by trained model 140 during supervised validation and not based on multipliers. Validation not based on multipliers is logically the same as validation based on identity multipliers whose values are one. Thus herein, point 0 is also referred to as identity point 0.

Every validation point is associated with its own distinct plurality of multipliers, which is one multiplier for each of multiple distinct protected groups 156-157 as discussed above. For example as shown, there may be two multipliers A-B respectively for two groups that each is associated with one value R or S. Herein, a validation is defined by its distinct plurality of multipliers.

Tri-objective genetic algorithm 170 maintains an evolving population of points. Each iteration of the evolution is referred to as a generation. A subset of points of a previous generation are replaced with newly generated points in a next generation, but replacement is not necessarily one for one. That is, each generation contains a population that consists of multiple points, and two generations may have populations of distinct respective sizes.

As discussed below, newly generated points are validation scored. Thus, all points in a generation have validation scores. Points in a generation may be ranked by validation score, and a better subset of points may be selected for: a) inclusion as is into a next generation and/or b) inclusion into a next generation after modification as follows.

A new point generated by tri-objective genetic algorithm 170 is either: a) a randomly imperfect copy of a better point or b) a random fusion (i.e. hybrid) of parts of two better points. In one example, randomly selected one, some, or all of multipliers A-B of a better point are adjusted by respective small random amounts. In another example, a randomly selected subset (i.e. not all) of multipliers A-B of an exact copy of a first randomly selected better point are replaced by the same subset of multipliers of a second randomly selected better point.

A state of the art initial population of a genetic algorithm is randomly generated. In that case, the many random initial points are clearly suboptimal, and a state of the art genetic algorithm may need a sequence of many generations before the population sufficiently evolves to contain a few points that are not clearly suboptimal. That initial sequence of clearly suboptimal generations is referred to herein as warm up, which entails much latency spent generating and validation scoring many clearly suboptimal new points. Because the many clearly suboptimal generated points will eventually be dominated as discussed below and discarded, warm up essentially is wasted computer time.

The points shown in tri-objective genetic algorithm 170 are an example initial population that contains innovative initial points 0 and 162-163. Random point 164 is an initial point that is not innovative. In an embodiment, the initial population of tri-objective genetic algorithm 170 consists almost entirely of many random points (not shown). In an embodiment of random point 164, each of multipliers A-B is randomly generated according to a gamma distribution. The lower bound of a gamma distribution is zero and, in an embodiment, there is no upper bound. In an embodiment, the statistical mean of the gamma distribution is one (i.e. multiplicative identity).

Herein, a nonrandom initial point is referred to as a designed point. Identity point 0 is a novel designed point. All designed points herein are innovative. Unlike a random point, a designed point is specially generated in a way that ensures that the designed point will be better than random for at least one of validation metrics 131-133. For example for validation metrics 131 and 133, respective validation scores O0 and A0 of identity point 0 are guaranteed to be optimal by design. Each of designed points 0 and 162-163 is generated in a distinct way as follows.

Novel parity point 162 is designed to provide statistical parity at a special favorable outcome rate as follows. Statistical parity means that all protected groups 156-157 have the same favorable outcome rate. It is novel that parity point 162 has statistical parity at the same favorable outcome rate as favorable outcome rate of majority protected group 156 for point 0, referred to herein as the baseline favorable outcome rate. In other words, multipliers A-B in parity point 162 have shown respective magnitudes A2-B2 that are whatever magnitudes will achieve the baseline favorable outcome rate for each of protected groups 156-157. Measurement of statistical parity depends on none of the features in input 110. Herein, statistical parity is a fairness metric that may or may not be fairness 132.

By design, parity point 162 is guaranteed to be optimal for favorable outcome rate decrease 133 and optimal for disparity that is discussed later herein. If fairness 132 is disparity, then parity point 162 also is optimal for fairness 132.

Novel opportunity point 163 is designed to provide equal opportunity, also referred to as equality of opportunity. Equal opportunity means that the favorable outcome rate does not depend on protected groups 156-157 nor on sensitive feature 120. For example, a first set and a second set of almost identical inputs (i.e. similar feature values) would have the same favorable outcome rate even if the first set excludes majority protected group 156 and the second set excludes protected group 157. In other words, multipliers A-B in opportunity point 163 have shown respective magnitudes A3-B3 that are whatever magnitudes will achieve a same favorable outcome rate for similar inputs in each of protected groups 156-157. Here, similar inputs means that, unlike statistical parity, measurement of equal opportunity depends on features in input 110. Herein, equal opportunity is a distinct fairness metric that may or may not be fairness 132.

By design, opportunity point 163 is nearly optimal for accuracy 131 and for disparity that is discussed later herein. If fairness 132 is disparity, then opportunity point 163 also is nearly optimal for fairness 132.

### 1.7 Optimizer Integration

In an embodiment, tri-objective genetic algorithm 170 may receive the validation scores of a validation point from computer 100. For example, computer 100 may receive the distinct plurality of multipliers of a new point (not shown) from tri-objective genetic algorithm 170, and computer 100 may evaluate the new point and provide the validation scores of the point back to tri-objective genetic algorithm 170. In that way, tri-objective genetic algorithm 170 may greedily or randomly (or a hybrid of both) explore and optimize in a multidimensional problem space that has a distinct dimension for each of distinct protected groups 156-157 for sensitive feature 120.

Each distinct validation (i.e. distinct plurality of multipliers) is a distinct point in that multidimensional problem space. With the addition of (e.g. three) dimensions respectively for three validation metrics 131-133, the multidimensional problem space becomes a multidimensional solution space in which each point has multiple multipliers and multiple validation scores, and tri-objective genetic algorithm 170 explores that multidimensional solution space.

### 1.8 Pareto Frontier

Tri-objective genetic algorithm 170 may retain multidimensional solution points (i.e. multipliers and validation scores) of some (e.g. best scoring) or all validations. For example, tri-objective genetic algorithm 170 may retain some or all of validation scores 180 and may, for example, generate a sequence of points with improving (e.g. increasing) validation scores. For example, tri-objective genetic algorithm 170 may select and retain a Pareto frontier that contains only non-dominated points that have the best validation scores and thus have the best multipliers. A dominated solution point is dominated by any point whose validation scores equal or exceed the scores of the dominated solution point, so long as at least one score is worse (e.g. lower) in the dominated solution point. A Pareto frontier contains at least one solution point or, without limit, more. In an embodiment, tri-objective genetic algorithm 170 does not provide a Pareto frontier to computer 100 until every generated point is validated (i.e. scored).

### 2.0 Example Classification Calibration Process

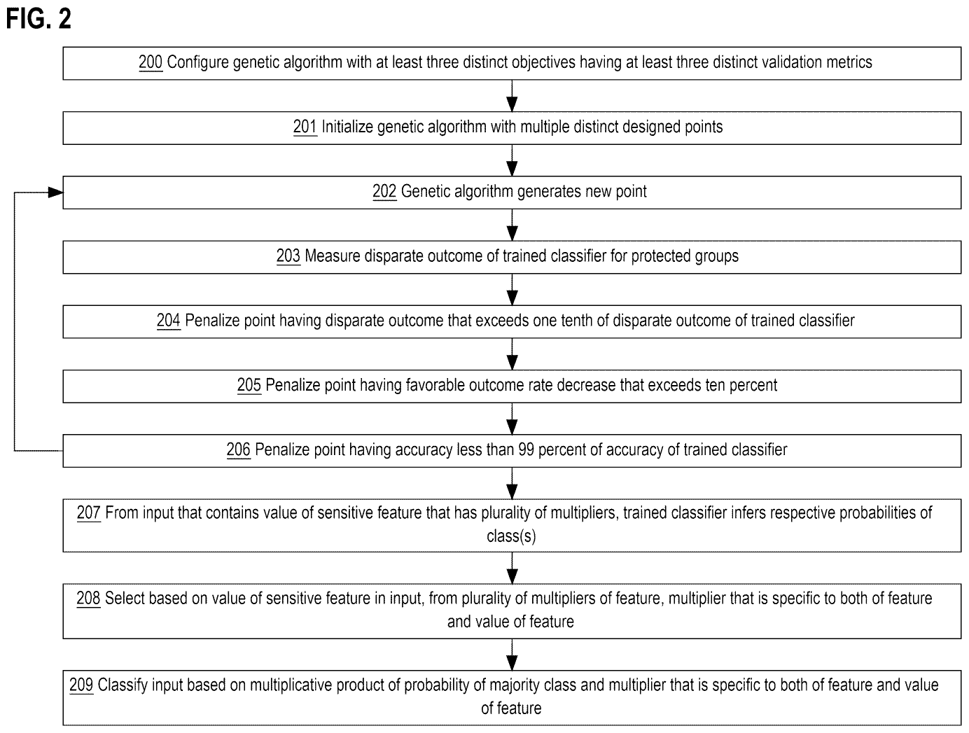

FIG. 2 is a flow diagram that depicts an example process that computer 100 may perform to calibrate classification using a best point whose generation by tri-objective genetic algorithm 170 is accelerated with designed points 0 and 162-163.

As discussed earlier herein, the lifecycle of multipliers A-B has an optimization phase followed by an application phase that may be performed on same or different computers in same or different environments. The optimization phase uses tri-objective genetic algorithm 170 to perform steps 200-206, after which tri-objective genetic algorithm 170 may be discarded. The application phase performs steps 207-209.

Steps 200-201 are preparatory and occur before evolutionary operation of tri-objective genetic algorithm 170. Step 200 configures tri-objective genetic algorithm 170 with at least three distinct quantitative objectives 191-193 having at least three distinct respective validation metrics 131-133 as discussed earlier herein.

Step 201 generates an initial population that contains multiple distinct designed points 0 and 162-163 and zero or more random points 164. Step 201 initializes tri-objective genetic algorithm 170 with the initial population.

Evolutionary operation of tri-objective genetic algorithm 170 entails steps 202-206. As discussed earlier herein, tri-objective genetic algorithm 170 performs a sequence of generations, and each generation generates multiple new points. Shown evolutionary steps 202-206 may be performed in various ways. Some of steps 202-206 may be repeated for each point generated. Some of steps 202-206 may instead be repeated once per generation and process multiple (e.g. all) points as a batch. General repetition of either way is demonstratively indicated by the backward arrow from step 206 to step 202.

Based on one or two existing points, tri-objective genetic algorithm 170 generates a new point in step 202 as discussed earlier herein. For acceleration and increased optimization accuracy, steps 203-206 apply constraints that decrease how much processing is wasted on clearly suboptimal points as follows.

Step 203 measures disparity of a point (i.e. a disparate outcome, which is how much lower is a favorable outcome rate of one protected group compared to the protected group with the highest favorable outcome rate for the point). Disparity is the difference between the highest favorable outcome rate of the point and the lowest favorable outcome rate of the point.

Step 204 penalizes the point when its disparate outcome exceeds one tenth of the disparate outcome of trained classifier 140 (i.e. the disparate outcome of identity point 0). Herein, penalization may entail either discarding the point or selecting the point at a decreased probability to generate a new point.

Step 205 measures favorable outcome rate decrease 133 of the point as discussed earlier herein. Step 205 penalizes the point when its favorable outcome rate decrease 133 measurement exceeds ten percent.

Step 206 measures accuracy 131 of the point as discussed earlier herein. Step 206 penalizes the point when its accuracy 131 measurement is less than 99 percent of accuracy of trained classifier 140 (i.e. accuracy A0 of identity point 0).

By definition, none of penalization steps 204-206 will penalize identity point 0. Any of penalization steps 204-206 is likely to penalize random point 164.

Eventually, the sequence of generations ceases, and tri-objective genetic algorithm 170 contains a final population that consists entirely or almost entirely of optimal non-dominated points. As follows, the subsequent application phase occurs. The application phase (i.e. steps 207-209) may be repeated more or less indefinitely without retraining trained classifier 140. A prerequisite of the application phase is selection of one preferred point from the final population of final points, and this selection may be automatic, heuristic, subjective, or experimental. Because all final points are non-dominated, each final point is a distinct optimal tradeoff between quantitative objectives 191-193. In one scenario and without retraining trained classifier 140, the application phase is repeated multiple times for a set of inputs, and each repetition of the application phase uses a distinct final point.

In this example, input 110 is new (i.e. was not in the validation corpus used by the optimization phase). For example, input 110 might not have existed during the optimization phase. From input 110 that contains value R of sensitive feature 120, trained classifier 140 infers probabilities PK, PL, and PM respectively for outcome classes K-M in step 207. In a binary classification embodiment, there are only two outcome classes K and M and trained classifier 140 infers only one probability PK for outcome class K, which can be subtracted from one to calculate probability PM for favorable outcome class M.

Herein, there are two distinct kinds of classification, and both are supported by the approaches herein. Binary classification has only two classes from which one class is predicted. Multiclass classification instead has more than two classes from which one class is predicted. Herein, classification and prediction may be synonyms. Herein multiclass means three or more classes. Herein, two classes is not multiclass.

A prerequisite of step 208 is selection of one preferred point from the final population of final points. Step 208 uses multipliers A-B of the preferred point. Based on value R of sensitive feature 120 in input 110, from multipliers A-B of sensitive feature 120, step 208 selects multiplier A that is specific to both of components 120 and R. Step 208 calculates a multiplicative product of probability PM of favorable outcome class M and multiplier A. This multiplicative product is referred to herein as the multiplied favorable probability or, for input 110, multiplied probability PM. That is, from input 110 are generated original probability PM and, from that, multiplied probability PM. Further processing by step 208 uses multiplied probability PM instead of original probability PM as follows.

Based on multiplied probability PM that is based on multiplier A, step 208 rescales probabilities 150 of all outcome classes K-M. Rescaling by step 208 entails unit normalizing unscaled probabilities 150 that do not sum to one (because multiplied probability PM is used), which generates rescaled probabilities 150 that sum to one without changing the relative probabilities of outcome classes K-M. For example, if unscaled probability PK is twice as big as unscaled probability PL, then rescaled probability PK still is twice as big as rescaled probability PL.

If rescaled multiplied probability PM is the highest rescaled probability in probabilities 150, then step 204 classifies input 110 as favorable outcome class M. Otherwise rescaled probability PK or PL is highest. Normalization by rescaling as discussed above may increase human interpretability.

### 2.1 Future Proofing

Classification can be recalibrated for classifying new inputs or reclassifying old inputs without retraining classifier 140, and reclassification of old inputs occurs without using trained classifier 140 at all. Recalibration effectively future proofs (i.e. avoids retraining) classifier 140 as follows. Trained classifier 140 may be needed only to infer original probabilities for new input(s). Reclassification of an old input using a different point in an old Pareto frontier occurs without using trained classifier 140 at all, without re-optimizing, and without using tri-objective genetic algorithm 170.

If at least one validation objective (e.g. validation metric) is replaced, re-optimization by tri-objective genetic algorithm 170 with an old validation corpus may generate a new Pareto frontier that contains new solution points. However, all of originally inferred probabilities 150 from all inputs in the validation corpus are reused for validation of the new solution points, which means that re-optimization with the old validation corpus does not use trained classifier 140. Even replacing tri-objective genetic algorithm 170 with a different tri-objective optimizer and then re-optimizing with the old validation corpus does not use trained classifier 140. In those ways, trained classifier 140 is future proofed for validation metrics that do not yet exist and future proofed for tri-objective optimizers that do not yet exist.

### 3.0 Example Generation of Parity Point

Here is example generation of parity point 162, and later herein is example generation of opportunity point 163. Although these two example designed point generations are different, both reuse an example outcome rate calibrator presented later herein and referred to herein as algorithm 1. In the following pseudocode that generates parity point 162, outcome rate metric OR may be the favorable outcome rate that, as discussed earlier herein, could be used to measure favorable outcome rate decrease 133 that the following pseudocode does not use.

Input:
A machine learning model M
A validation dataset D
An outcome rate metric OR
A threshold search resolution
Output:
A set of Multiplier Tuning multipliers
Procedure:

| 1. | Compute the predictions Y and prediction probabilities P of | |
|---|---|---|
| | D using M | |
| 2. | For each protected group G | |
| | a. | compute the outcome rate of G : OR(Y_{G}). |
| | b. | Let oₘₐₓbe the best outcome rate across groups. |
| 3. | For each protected group G: | |
| | a. | Apply Algorithm 1, with inputs oₘₐₓ, P_{G}, and the |
| | | input threshold search resolution. |

| | |
|---|---|
| 4. | Return the multipliers computed by step 6a for each group. |

### 3.1 Example Generation of Opportunity Point

Here is example generation of opportunity point 163 by reuse of algorithm 1 that is presented later herein. In the following pseudocode that generates opportunity point 163, outcome rate metric OR is as discussed above for generation of parity point 162.

The following pseudocode uses a fairness metric referred to as equality of odds. Equality of odds is somewhat similar to equality of opportunity as discussed earlier herein. Both depend on favorable outcome rates. However unlike equality of opportunity, equality of odds further depends on fair equality of false negative rates. In other words, equal odds is stricter (i.e. more fair) than equal opportunity. Even though the following pseudocode internally uses equal odds, the pseudocode generates and returns opportunity point 163 that instead implements equal opportunity. In the following pseudocode, M′ (i.e. M-apostrophe) is a set of multipliers A-B that achieve equal odds between protected groups 156-157.

Input:
A machine learning model M
A validation dataset D
An outcome rate metric OR
A threshold search resolution
Output:
A set of Multiplier Tuning multipliers
Procedure:

| 5. | Let M′ be the model obtained by running the Equality of Odds on D. | |
|---|---|---|
| 6. | Let Y′ be the predictions made by M′ on D. | |
| 7. | Let o_{EO} = OR(Y′) be the outcome rate of D under M′ | |
| 8. | For each protected group G: | |
| | a. | Let P_{G} be the class probabilities predicted by M on D for |
| | | group G |
| | b. | Apply Algorithm 1, with inputs O_{EO}, P_{G}, and the input threshold |
| | | search resolution. |

| | |
|---|---|
| 9. | Return the multipliers computed by step 6b for each group. |

### 3.2 Example Outcome Rate Calibrator Algorithm 1

Here is example algorithm 1 that performs outcome rate calibration as follows. The following pseudocode is reusable and parameterized as follows. Protected group G is one of protected groups 156-157. Target outcome rate o is a given outcome rate that algorithm 1 should achieve for protected group G by performing a one-dimensional grid search. Threshold search resolution T is a sequence of uniformly spaced individual thresholds t on the grid. For input 110, for example, threshold t is a probability threshold that original (i.e. without multipliers A-B, i.e. with identity point 0) probability PM should exceed for input 110 to be classified as favorable outcome class M. Thus, the one dimension of the grid is probability that naturally ranges from zero to one. Likewise, each threshold t in T is in a range from zero to one.

The following pseudocode operates as if it were to demonstratively generate, for its own internal use only, a distinct imperfect copy of identity point 0 for each threshold t in T, in which the multiplier associated with protected group G would be distinct in each imperfect copy. For example if protected group G were protected group 157 then, in each imperfect copy, multiplier A would be one, and multiplier B would be a respective distinct magnitude. However in an embodiment, the following pseudocode does not actually generate points and does not actually generate a distinct multiplier magnitude for each threshold tin T. In the following pseudocode, step 11.c retains whichever threshold achieved a favorable outcome rate nearest to target outcome rate o. Step 12 converts that threshold into a multiplier for the one of values R-S that is associated with protected group G, which is only one multiplier and not a point that contains a plurality of multipliers A-B. For example if protected group G is protected group 157, then step 12 generates multiplier B but not A. In that case, the following pseudocode can be invoked again to instead generate multiplier A using majority protected group 156 as protected group G.

```
Input:
      A target Outcome Rate (o).
      Prediction probabilities (P_{G}) given by the original ML model to the protected group
      G.
      A threshold search resolution: an integer defining how many thresholds are searched
      when approximating the OR.
Output:
      A Multiplier Tuning multiplier that, when applied, approximates the target OR for
      G.
Procedure:
10. let T be a sequence of threshold_search_resolution real-valued, linearly spaced
    numbers between 0 and 1 exclusive. Add the default threshold of 0.5 to T
11. For each threshold t in T,
    a. Let P_{G}′ be the labels derived from prediction probabilities P_{G}, thresholded with t.
    b. Compute the outcome rate of P_{G}′
    c. Let t_{G} be the threshold that obtains the closest outcome rate to the target o for
      subgroup G. If two thresholds produce outcome rates that are equally close to the
      target, break ties by picking the threshold closest to 0.5.
$12. Convert {t}_{G} into the multiplier {m}_{G} by the following formula : {m}_{G} = \frac{( 1 - {t}_{G} )}{{t}_{G}}$
13. Return m_{g}
```

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

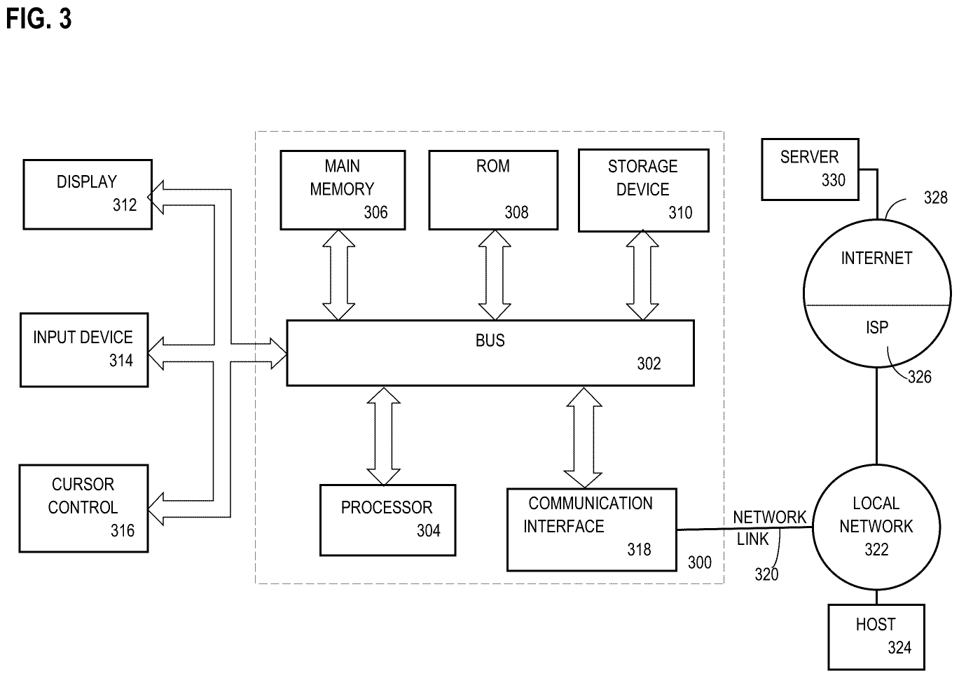

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

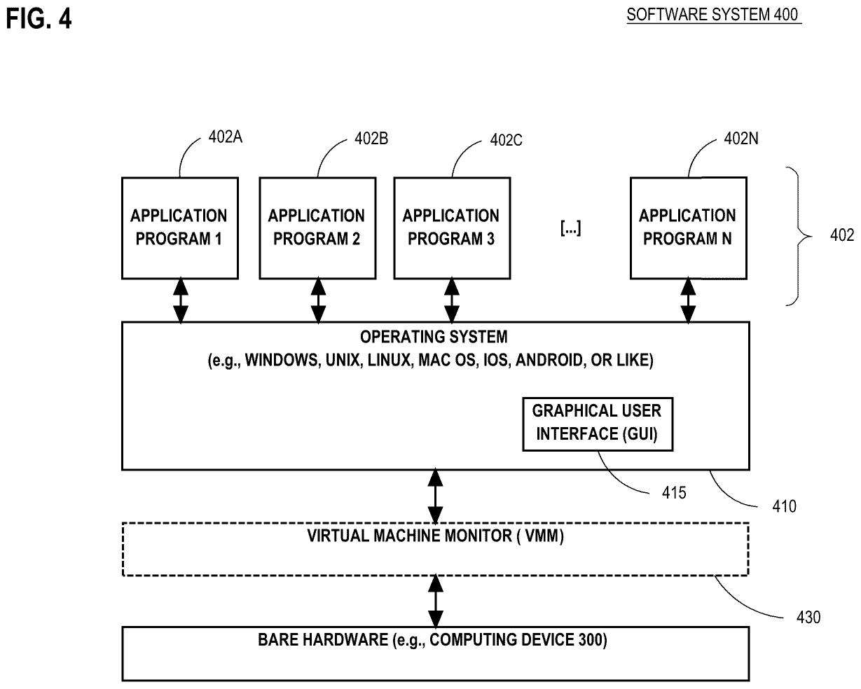

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
initializing a genetic algorithm with a plurality of points, wherein:
each point in the plurality of points specifies, for each protected group of a plurality of protected groups, a multiplier of a feature, and
the plurality of points contains at least one point selected from a group consisting of:
a point that specifies multipliers for the plurality of protected groups that maximize a fairness for the plurality of protected groups, and
a point that specifies multipliers for the plurality of protected groups that maximize an accuracy of a machine learning model;
generating, by the genetic algorithm, a new plurality of multipliers of the feature;
inferring, from an input that contains a value of the feature, a probability of a class;
selecting based on the value of the feature in the input, from the new plurality of multipliers of the feature, a multiplier that is specific to both of the feature and the value of the feature; and
classifying the input based on a multiplicative product of the probability of the class and the multiplier that is specific to both of the feature and the value of the feature;
wherein the method is performed by one or more computers.

2. The method of claim 1 wherein the plurality of points contains at least one point selected from a group consisting of:
a point that specifies a multiplicative identity for the multiplier of each protected group of the plurality of protected groups,
a point that specifies multipliers for the plurality of protected groups that maximizes an equality of opportunity of the plurality of protected groups,
a point that specifies multipliers for the plurality of protected groups that minimizes a disparate outcome of the plurality of protected groups, and
a point that specifies multipliers for the plurality of protected groups that minimizes an outcome rate decrease of the plurality of protected groups.

3. The method of claim 1 wherein the plurality of points contains at least two points that are not randomly generated.

4. The method of claim 1 further comprising:
measuring a disparate outcome of the machine learning model for the plurality of protected groups;
penalizing points having a disparate outcome for the plurality of protected groups that exceeds one tenth of a disparate outcome of the machine learning model.

5. The method of claim 1 further comprising:
measuring an accuracy of the machine learning model;
penalizing points having an accuracy less than 99 percent of the accuracy of the machine learning model.

6. The method of claim 1 further comprising penalizing points having an outcome rate decrease for the plurality of protected groups that exceeds ten percent.

7. The method of claim 1 further comprising configuring the genetic algorithm with at least three distinct validation metrics, including a fitness metric and a fairness metric.

8. The method of claim 1 further comprising configuring the genetic algorithm with at least three distinct validation metrics, including two fairness metrics.

9. The method of claim 1 further comprising configuring the genetic algorithm with at least three distinct objectives, including an objective that minimizes an outcome rate decrease of the plurality of protected groups.

10. The method of claim 1 further comprising:
the genetic algorithm generating multiple pluralities of multipliers of the feature;
detecting a subset of the multiple pluralities of multipliers of the feature that are on a tri-objective Pareto frontier.

11. One or more non-transitory computer-readable media storing instructions that, when executed by one or more processors, cause:
initializing a genetic algorithm with a plurality of points, wherein:
each point in the plurality of points specifies, for each protected group of a plurality of protected groups, a multiplier of a feature, and
the plurality of points contains at least one point selected from a group consisting of:
a point that specifies multipliers for the plurality of protected groups that maximize a fairness for the plurality of protected groups, and
a point that specifies multipliers for the plurality of protected groups that maximize an accuracy of a machine learning model;
generating, by the genetic algorithm, a new plurality of multipliers of the feature;
inferring, from an input that contains a value of the feature, a probability of a class;
selecting based on the value of the feature in the input, from the new plurality of multipliers of the feature, a multiplier that is specific to both of the feature and the value of the feature; and
classifying the input based on a multiplicative product of the probability of the class and the multiplier that is specific to both of the feature and the value of the feature.

12. The one or more non-transitory computer-readable media of claim 11 wherein the plurality of points contains at least one point selected from a group consisting of:
a point that specifies a multiplicative identity for the multiplier of each protected group of the plurality of protected groups,
a point that specifies multipliers for the plurality of protected groups that maximizes an equality of opportunity of the plurality of protected groups,
a point that specifies multipliers for the plurality of protected groups that minimizes a disparate outcome of the plurality of protected groups, and
a point that specifies multipliers for the plurality of protected groups that minimizes an outcome rate decrease of the plurality of protected groups.

13. The one or more non-transitory computer-readable media of claim 11 wherein the plurality of points contains at least two points that are not randomly generated.

14. The one or more non-transitory computer-readable media of claim 11 wherein the instructions further cause:
measuring a disparate outcome of the machine learning model for the plurality of protected groups;
penalizing points having a disparate outcome for the plurality of protected groups that exceeds one tenth of a disparate outcome of the machine learning model.

15. The one or more non-transitory computer-readable media of claim 11 wherein the instructions further cause:
measuring an accuracy of the machine learning model;
penalizing points having an accuracy less than 99 percent of the accuracy of the machine learning model.

16. The one or more non-transitory computer-readable media of claim 11 wherein the instructions further cause penalizing points having an outcome rate decrease for the plurality of protected groups that exceeds ten percent.

17. The one or more non-transitory computer-readable media of claim 11 wherein the instructions further cause configuring the genetic algorithm with at least three distinct validation metrics, including a fitness metric and a fairness metric.

18. The one or more non-transitory computer-readable media of claim 11 wherein the instructions further cause configuring the genetic algorithm with at least three distinct validation metrics, including two fairness metrics.

19. The one or more non-transitory computer-readable media of claim 11 wherein the instructions further cause configuring the genetic algorithm with at least three distinct objectives, including an objective that minimizes an outcome rate decrease of the plurality of protected groups.

20. The one or more non-transitory computer-readable media of claim 11 wherein the instructions further cause:
the genetic algorithm generating multiple pluralities of multipliers of the feature;
detecting a subset of the multiple pluralities of multipliers of the feature that are on a tri-objective Pareto frontier.
